(19) United States
(12) Patent Application Publication
(10) Pub. No.: US 2010/0107236 A1
(43) Pub. Date: Apr. 29, 2010

(54) NETWORK SYSTEM, COMMUNICATION METHOD, COMMUNICATION TERMINAL, AND COMMUNICATION PROGRAM

(76) Inventor: Shozo Fujino, Tokyo (JP)

Correspondence Address: Mr. Jackson Chen, 6535 N. STATE HWY 161, IRVING, TX, 75039, US

(21) Appl. No.: 12/529,433

(22) PCT Filed: Mar. 10, 2008
(86) PCT No.: PCT/JP2008/054293

§ 371 Date: Sep. 1, 2009

(30) Foreign Application Priority Data
Mar. 9, 2007 (JP) 2007-061104

(51) Int. Cl. H04L 12/56; H04L 12/46; H04B 7/26; H04L 12/28

(52) U.S. Cl. 726/12; 726/13

(57) ABSTRACT

Provided is a network system which attains effective prevention of information leakage without having a user recognize existence of spy ware or the like operating on a user terminal.

With a peripheral terminal 7 using a broadband network 3 and a portable terminal 8 using a cellular network 2 connected by a network 1, when the peripheral terminal 7 accesses other service network 4, the portable terminal 8 transmits, to the peripheral terminal 7, forwarding setting information formed to make connection from the broadband network 3 to other service network 4 via the portable terminal or make connection to other service network 4 via the portable terminal 8 and a gateway device 22 of the cellular network 2, and when a packet communicated between the peripheral terminal 7 and the service network is malware, the portable terminal 8 or the gateway device 22 abandons the packet and when not malware, transfers the packet according to the forwarding setting information.

### TECHNICAL FIELD

The present invention relates to an information leakage prevention method of a network system connected to the Internet or an external private network by a user and, more particularly, to a network system, a communication method, a communication terminal and a communication program which realize a firewall function using a terminal such as a portable terminal.

### BACKGROUND ART

As access techniques used when a user connects to the Internet or an external private network, there exist various techniques such as WCDMA or cdma2000 as a cellular radio system, Wi-Fi as a fixed radio system, WiMAX as a mobile radio system and ADSL or FTTH as a fixed wired system. Cellular phone as a cellular terminal can be connected to a peripheral apparatus by WLAN, Bluetooth, IrDA, USB or the like other than network connection I/F such as WCDMA.

Mobile communication standardization organization currently proposes architecture of a network formed of a cellular phone under the user control and a plurality of peripheral terminals which are located surrounding the phone and are connected by a short distance, which network is called PAN (Personal Area Network).

Under a network connection environment for a user, since spy ware which transmits input history information from a keyboard such as a password or a credit card number to a third party and a Peer to Peer (P2P) application such as Winny which transmits personal information including an address or a mail address preserved in a storage device such as a hardware disk device to a third party (such harmful software as the above-described spy ware or Peer to Peer (P2P) application such as Winny is called malware) are in some cases executed in the background without user's notice, the user is always subjected to information leakage.

Patent Literature 1: Japanese Translation of PCT International Patent Application No. 2003-529243.

When a user executes network connection, there exists a possibility of executing such spy ware as described above which is enclosed at the time of downloading other software without comprehending its existence.

When a public terminal is used at a radio LAN spot or the like, such a P2P application as Winny might be executed in the background without user's notice.

In the above-described cases, there is a danger that secret information or personal information input through a keyboard or preserved in a storage might flow out to a third party.

Under such a condition, while there exists a method of sensing execution of such malware as described above in advance, when connecting to other service network, with virus checking software or information leakage prevention software such as a process monitor installed on a peripheral terminal in advance, it is necessary at every communication with other service network to confirm inclusion of malware in data to be transmitted and when such malware is included, communication should be executed after deleting the malware, which is extremely troublesome.

Disclosed in Patent Literature 1 is an example of a communication system which, at the time of an access to specific network service by a user terminal, connects a mobile phone having a security function or a firewall function as a gateway to block an unauthorized access to network service from a user terminal, as well as enabling an access with such security maintained as prevents intrusion of data viruses by an access to the network service.

While the communication system recited in the above-described Patent Literature 1 enables an unauthorized access to network service by a user terminal or intrusion of data viruses to the user terminal from the network service to be prevented in advance, it fails to prevent leakage of personal information from the user terminal caused by spy ware or the like operable on the user terminal.

For preventing such situations, it is necessary to install information leakage prevention software on a user terminal in advance to check inclusion of malware in data to be transmitted as described above.

In addition, the communication system recited in Patent Literature 1 has a problem that since a connection path used at the time of an access to other network service by a user terminal is limited only to a predetermined connection path with the above-described mobile phone as a gateway, connection to other network service by a user terminal is impossible by using various network connection modes.

### OBJECTS OF THE INVENTION

An object of the present invention is to provide a network system, a communication method, a communication terminal and a communication program which enable effective prevention of information leakage without user's recognizing existence of an application (malware) such as spy ware operable on a user terminal.

Other object of the present invention is to provide a network system, a communication method, a communication terminal and a communication program which are allowed to receive communication service with high security in various modes of network connection to other network service by using a user terminal such as a portable terminal while preventing information leakage by using the user terminal.

A further object of the present invention is to provide a network system, a communication method, a communication terminal and a communication program which realizes prevention of information leakage without installing large-scale software on a user terminal such as virus checking software or process monitor.

### SUMMARY

According to a first aspect of the invention, a network system with a first user terminal which uses a first service network and a second user terminal which uses a second service network connected by a first network, wherein when the first user terminal accesses other service network through the first service network,

the second user terminal transmits, to the first user terminal, forwarding setting information formed to connect to the first service network via the second user terminal, and

when a packet communicated between the first user terminal and the other service network is malware, the second user terminal abandons the packet and when not malware, transfers the packet according to the forwarding setting information.

According to a second aspect of the invention, a network system with a first user terminal which uses a first service network and a second user terminal which uses a second service network connected by a first network, wherein when the first user terminal accesses other service network through the second service network,

the second user terminal transmits, to the first user terminal, forwarding setting information formed to connect to the second service network via the second user terminal, and

when a packet communicated between the first user terminal and the other service network is malware, a gateway device of the second service network abandons the packet and when not malware, transfers the packet.

According to a third aspect of the invention, a network system with a first user terminal which uses a first service network and a second user terminal which uses a second service network connected by a first network, wherein when the first user terminal accesses other service network,

the second user terminal transmits, to the first user terminal, forwarding setting information formed to connect to the other service network from the first service network via the second user terminal or formed to connect to the other service network via the second user terminal and a gateway device of the second service network, and

when a packet communicated between the first user terminal and the other service network is malware, the second user terminal or the gateway device abandons the packet and when not malware, transfers the packet according to the forwarding setting information.

According to a fourth aspect of the invention, a communication method in a network system with a first user terminal which uses a first service network and a second user terminal which uses a second service network connected by a first network, wherein when the first user terminal accesses other service network through the first service network,

the second user terminal transmits, to the first user terminal, forwarding setting information formed to connect to the first service network via the second user terminal, and

when a packet communicated between the first user terminal and the other service network is malware, the second user terminal abandons the packet and when not malware, transfers the packet according to the forwarding setting information.

According to a fifth aspect of the invention, a communication method in a network system with a first user terminal which uses a first service network and a second user terminal which uses a second service network connected by a first network, wherein when the first user terminal accesses other service network through the second service network,

the second user terminal transmits, to the first user terminal, forwarding setting information formed to connect to the second service network via the second user terminal, and

when a packet communicated between the first user terminal and the other service network is malware, a gateway device of the second service network abandons the packet and when not malware, transfers the packet.

According to a sixth aspect of the invention, a communication method in a network system with a first user terminal which uses a first service network and a second user terminal which uses a second service network connected by a first network, wherein when the first user terminal accesses other service network,

the second user terminal transmits, to the first user terminal, forwarding setting information formed to connect to the other service network from the first service network via the second user terminal or formed to connect to the other service network via the second user terminal and a gateway device of the second service network, and

when a packet communicated between the first user terminal and the other service network is malware, the second user terminal or the gateway device abandons the packet and when not malware, transfers the packet according to the forwarding setting information.

According to a seventh aspect of the invention, a communication terminal connected by a network to a user terminal which uses a first service network to use second service network, comprising, when the user terminal accesses other service network through the first service network:

a unit which transmits, to the user terminal, forwarding setting information formed to connect to the first service network via the communication terminal;

a unit which abandons, when a packet communicated between the user terminal and the other service network is malware, the packet; and

a unit which transfers, when a packet is not malware, the packet according to the forwarding setting information.

According to a eighth aspect of the invention, a communication program for controlling communication in a network system with a first user terminal which uses a first service network and a second user terminal which uses a second service network connected by a first network, which when the first user terminal accesses other service network via the first service network, causes the second user terminal to execute:

a function of transmitting, to the first user terminal, forwarding setting information formed to connect to the first service network via the second user terminal; and

a function of abandoning, when a packet communicated between the first user terminal and the other service network is malware, the packet, and transferring, when a packet is not malware, the packet according to the forwarding setting information. According to a seventh aspect of the invention,

According to a ninth aspect of the invention, a communication program for controlling communication in a network system with a first user terminal which uses a first service network and a second user terminal which uses a second service network connected by a first network, which when the first user terminal accesses other service network through the second service network, causes,

the second user terminal to execute the function of transmitting, to the first user terminal, forwarding setting information formed to connect to the second service network via the second user terminal, and

a gateway device of the second service network to execute the function of abandoning, when a packet communicated between the first user terminal and the other service network is malware, the packet, and when a packet is not malware, transferring the packet.

The present invention attains the following effects.

Prevention of information leakage can be effectively attained without user's recognition of existence of an application (malware) such as spy ware which is operating on a user terminal.

While preventing information leakage by using a user terminal such as a portable terminal, communication service whose security is high in various modes of network connection to other network service using the user terminal can be received.

Information leakage prevention can be realized without installing large-scale software on a user terminal such as virus checking software or process monitor.

### BRIEF DESCRIPTION OF THE DRAWINGS

FIG. 1 is a block diagram showing a structure of a network system according to a first mode of implementation of the present invention;

FIG. 2 is a diagram for use in explaining operation executed when a portable terminal is a multi-access terminal in the network system according to the first mode of implementation of the present invention;

FIG. 3 is a flow chart for use in explaining operation of the portable terminal in the network system according to the first mode of implementation of the present invention;

FIG. 4 is a diagram for use in explaining operation executed when a portable terminal is a single-access terminal in the network system according to the first mode of implementation of the present invention;

FIG. 5 is a block diagram showing a structure of a network system according to a second mode of implementation of the present invention;

FIG. 6 is a diagram for use in explaining operation executed in the network system according to the second mode of implementation of the present invention;

FIG. 7 is a flow chart for use in explaining operation of the portable terminal in the network system according to the second mode of implementation of the present invention;

FIG. 8 is a flow chart for use in explaining operation of a gateway device in the network system according to the second mode of implementation of the present invention;

FIG. 9 is a block diagram showing a structure and operation of a first exemplary embodiment corresponding to the first mode of implementation according to the present invention;

FIG. 10 is a block diagram showing a structure and operation of the first exemplary embodiment corresponding to the second mode of implementation according to the present invention; and

FIG. 11 is a diagram showing a hardware structure of a portable terminal in it network system according to the present invention.

### EXEMPLARY EMBODIMENT

In the following, modes of implementation of the present invention will be detailed with reference to the drawings.

### (First Mode of Implementation)

### (Description of Structure)

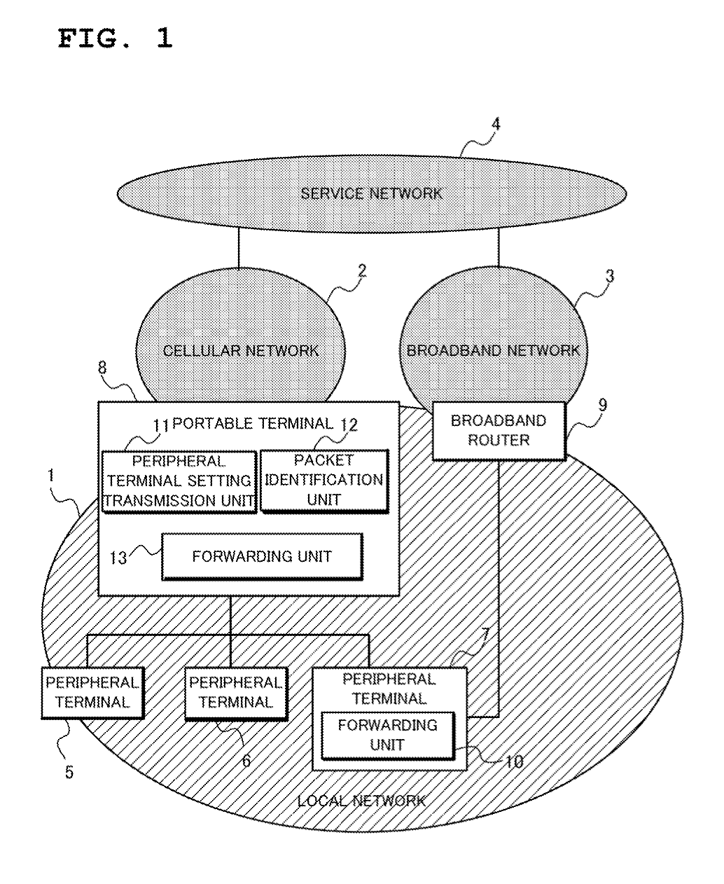

Structure of a network system according to the first mode of implementation of the present invention is shown in FIG. 1.

In the network system according to the present mode of implementation shown in FIG. 1, a service network 4 is the Internet or an external private network.

A portable terminal 8 is a terminal which subscribes to service of a cellular network 2 as a service network to use the service and comprises a peripheral terminal setting transmission unit 11, a packet identification unit 12 and a forwarding unit 13.

The portable terminal 8, peripheral terminals 5, 6 and 7 as a user terminal, and a broadband router 9 are connected with each other by a local network 1. The peripheral terminal 7 is a terminal which subscribes to service of a broadband network 3 as a service network and comprises a forwarding unit 10.

Hardware structure of the portable terminal 8 will be here described in brief.

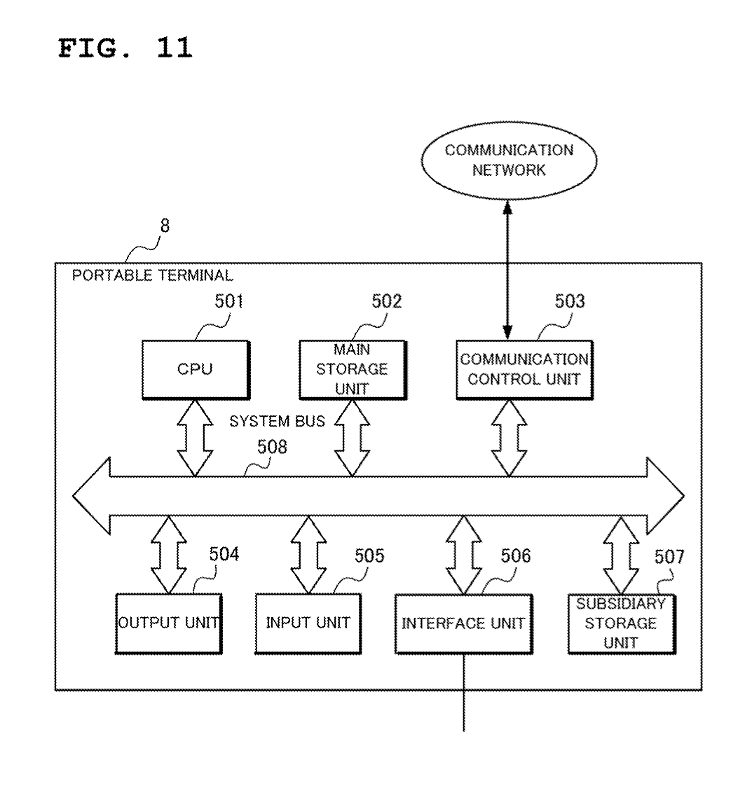

FIG. 11 is a block diagram showing an example of a hardware structure of the portable terminal 8 of the network system according to the present mode of implementation.

With reference to FIG. 11, the portable terminal 8 according to the present invention, which can be realized by the same hardware structure as that of a common computer device, comprises a CPU (Central Processing Unit) 501, a main storage unit 502 as a main memory such as RAM (Random Access Memory) for use as a data working region or a data temporary saving region, a communication control unit 503 for transmitting/receiving data through a communication network such as the Internet, an output unit 504 such as a liquid crystal display, a printer or a speaker, an input unit 505 such as a keyboard or a mouse, an interface unit 506 connected to a peripheral apparatus to transmit/receive data, a subsidiary storage unit 507 as a hard disk device formed of a non-volatile memory such as a ROM (Read Only Memory), a magnetic disk or a semiconductor memory, and a system bus 508 for connecting each of the above-described components of the present information processing device with each other.

The portable terminal 8 according to the present invention not only allows its operation to be realized in hardware with a circuit part mounted which is formed of a hardware part such as an LSI (Large Scale Integration) having a program realizing a relevant function incorporated into the portable terminal 8 but also allows its operation to be realized in software by executing a program providing each function of each of the above-described components by the above-described CPU 501.

More specifically, the CPU 501 loads the program stored in the subsidiary storage unit 507 into the main storage unit 502 and executes the same, thereby realizing the functions of the peripheral terminal setting transmission unit 11, the packet identification unit 12 and the forwarding unit 13 of the portable terminal 8 in software.

Also as to the peripheral terminal 7 (peripheral terminals 5 and 6), its basic hardware structure is the same as the foregoing hardware structure of the portable terminal 8.

### (Description of Operation)

Next, operation of the network system according to the first mode of implementation will be described with reference to FIG. 1 through FIG. 4.

The portable terminal 8 owned by a user is a multi-access terminal having a wide band direct link with the broadband router 9 other than a connection link with the cellular network 2 in one case and is a single-access terminal having only the connection link with the cellular network 2 in another case.

(1) In Case where Portable Terminal is Multi-Access Terminal

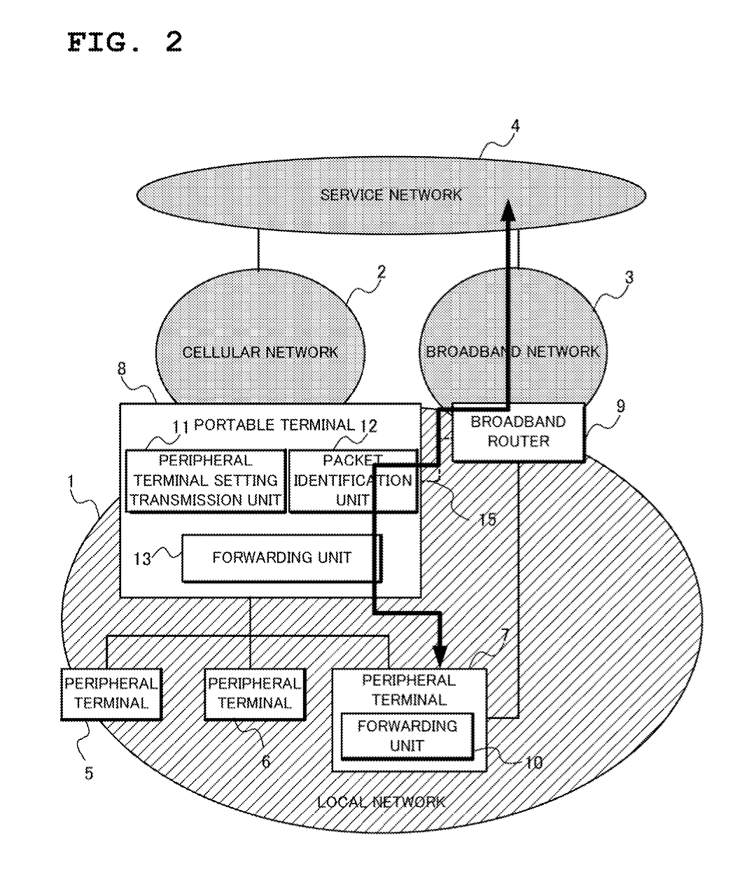

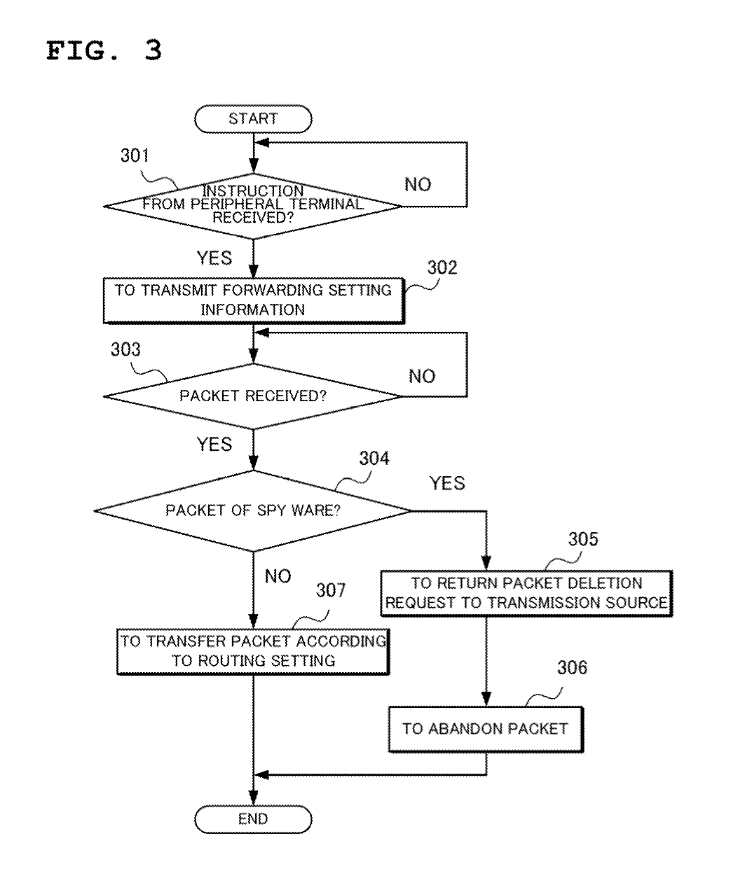

Description will be made of operation executed when the portable terminal 8 is a multi-access terminal having a wide band direct link 15 with the broadband router 9 other than a connection link with the cellular network 2 with reference to FIG. 2 and FIG. 3. In FIG. 2, an arrow indicates a flow of a packet in an upstream or downstream direction. FIG. 3 is a flow chart showing operation of the portable terminal 8.

When a user wants to prevent information flow by using a packet identification function at the time of an access from the peripheral terminal 7 to the service network 4, a user interface UI on the portable terminal 8 is given an instruction to that effect.

Upon receiving the instruction from the peripheral terminal 7 (Step 301), by means of the peripheral terminal setting transmission unit 11, the portable terminal 8 transmits, to the peripheral terminal 7, forwarding setting information formed to use only a direct link between the two terminals but not a link between the peripheral terminal 7 and the broadband router 9 at the time of communication (Step 302).

Set at the forwarding setting information is that all the communication by the peripheral terminal 7 is executed not by the use of a link with the broadband router 9 but by the connection by the broadband router 9 via the portable terminal 8.

The forwarding unit 10 of the peripheral terminal 7 will execute all the communication by connection by the broadband router 9 via the portable terminal 8 according to the forwarding setting information received from the portable terminal 8.

The packet identification unit 12 of the portable terminal 8 once intercepts a packet passing upstream or downstream and receives the same (Step 303) and refers to header information of the packet to determine whether the packet includes malware such as spy ware (Step 304).

Upon detecting a packet including malware such as spy ware, the packet identification unit 12 returns a deletion request with a copy of the packet attached (together with alarming information that the packet is spy ware or the like) to a transmission source such as the peripheral terminal 7 (Step 305) and abandons the packet without transferring the same (Step 306).

Thus, by returning a packet deletion request to a transmission source, further transmission of a packet of the same kind from the same transmission source can be suppressed.

When the determination is made at Step 304 that it is not a packet including malware such as spy ware, the forwarding unit 13 of the portable terminal 8 transfers the received packet according to the routing setting (Step 307).

As to an upstream packet not abandoned by the packet identification unit 12, the forwarding unit 13 of the portable terminal 8 transfers the packet not to the cellular network 2 side but to the direct link with the broadband router 9 to transmit the same by using the broadband network 3.

Similarly, a downstream packet will be directly received by the portable terminal 8 from the broadband router 9 and forwarded to the peripheral terminal 7.

(2) In Case where Portable Terminal is Single-Access Terminal

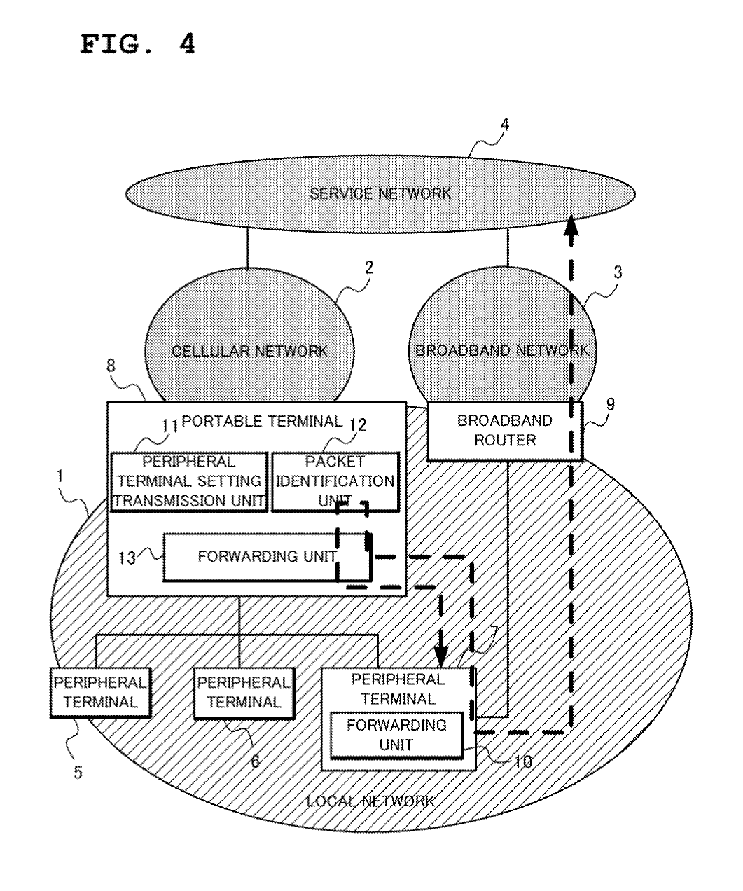

Description will be made of operation executed when the portable terminal 8 is a single-access terminal having only a connection link with the cellular network 2 with reference to FIG. 3 and FIG. 4. In FIG. 4, an arrow indicates a flow of a packet in an upstream or downstream direction.

When a user wants to prevent information flow by using the packet identification function at the time of an access from the peripheral terminal 7 to the service network 4, the UI on the portable terminal 8 is given an instruction to that effect.

Upon receiving the instruction from the peripheral terminal 7 (Step 301), the peripheral terminal setting transmission unit 11 of the portable terminal 8 transmits, to the peripheral terminal 7, forwarding setting information formed to operate as a bridge for a packet again received from the portable terminal 8 to connect to the broadband router 9, with the portable terminal 8 as a Default Gateway at the time of communication (Step 302).

The forwarding unit 10 of the peripheral terminal 7 will operate as a bridge in communication between the portable terminal 8 and the broadband router 9, with the portable terminal 8 as the Default Gateway according to the forwarding setting information received from the portable terminal 8.

The packet identification unit 12 of the portable terminal 8 once intercepts a packet passing upstream or downstream and receives the same (Step 303), and refers to header information of the packet to determine whether the packet includes data of malware such as spy ware (Step 304).

Upon detecting a packet including malware such as spy ware, return a deletion request with a copy of the packet attached (together with alarming information that the packet includes malware such as spy ware or the like) to a transmission source such as the peripheral terminal 7 (Step 305) and abandon the packet without transferring the same (Step 306).

Thus, by returning a packet deletion request to a transmission source, further transmission of a packet of the same kind from the same transmission source can be suppressed.

When the determination is made at Step 304 that it is not a packet including malware such as spy ware, the forwarding unit 13 of the portable terminal 8 transfers the received packet according to the routing setting (Step 307).

As to an upstream packet not abandoned by the packet identification unit 12, the forwarding unit 13 of the portable terminal 8 makes L2 connection with a LAN side MAC address of the broadband router 9 as a destination to transmit the packet to the broadband network 3 with the peripheral terminal 7 as a bridge.

Similarly, a downstream packet will be passed through the portable terminal 8 from the broadband router 9 with the peripheral terminal 7 as a bridge and again forwarded to the peripheral terminal 7.

### (Second Mode of Implementation)

### (Description of Structure)

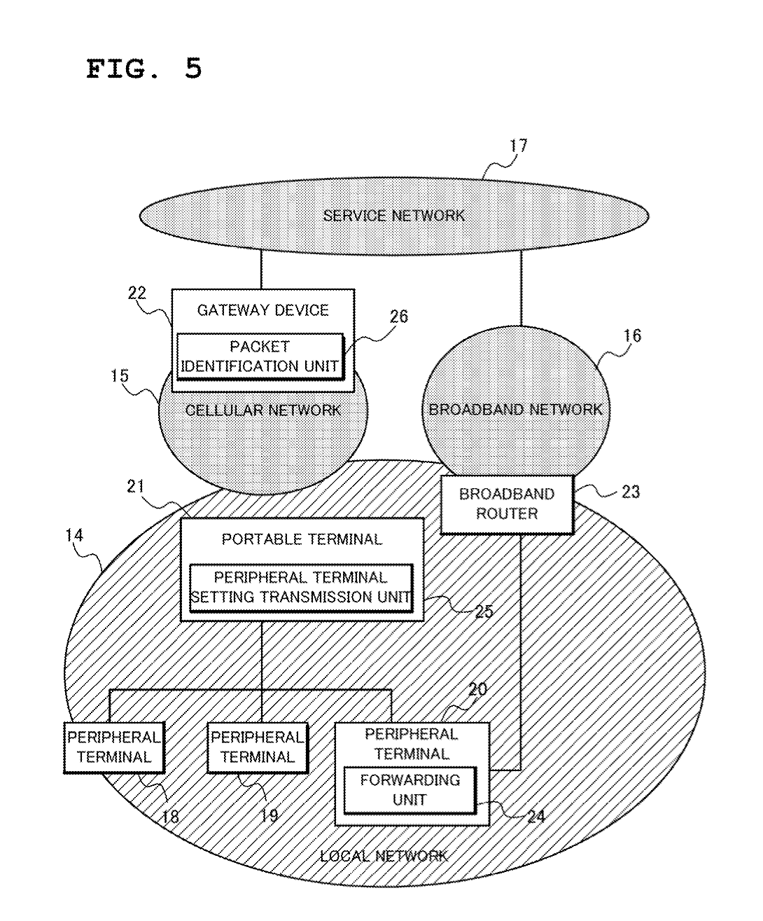

Structure of a network system according to a second mode of implementation of the present invention is shown in FIG. 5.

In the network system according to the present mode of implementation shown in FIG. 5, a service network 17 is the Internet or an external private network.

A portable terminal 21 is a terminal which subscribes to service of a cellular network 15 to use the service and comprises a peripheral terminal setting transmission unit 25.

A gateway device 22 is a gateway device under the management of an operator of the cellular network 15, which comprises a packet identification unit 26.

The portable terminal 21, peripheral terminals 18, 19 and 20 as a user terminal, and a broadband router 23 are connected with each other by a local network 14. The peripheral terminal 20 is a terminal which subscribes to service of a broadband network 16 and comprises a forwarding unit 24.

### (Description of Operation)

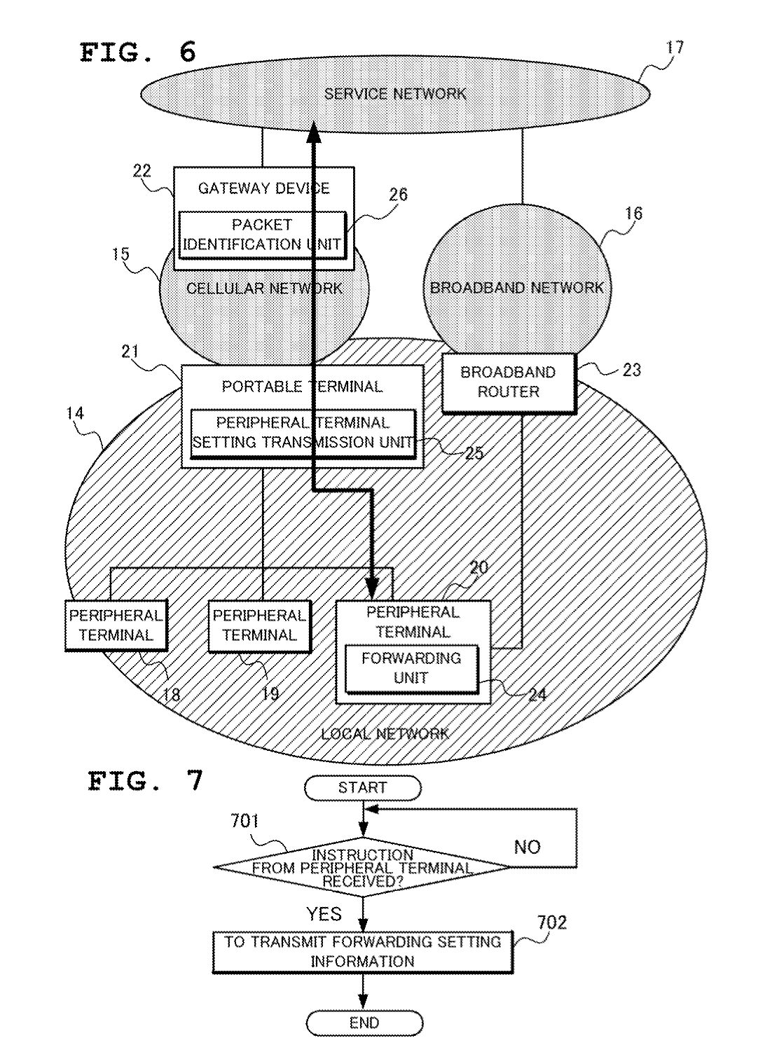

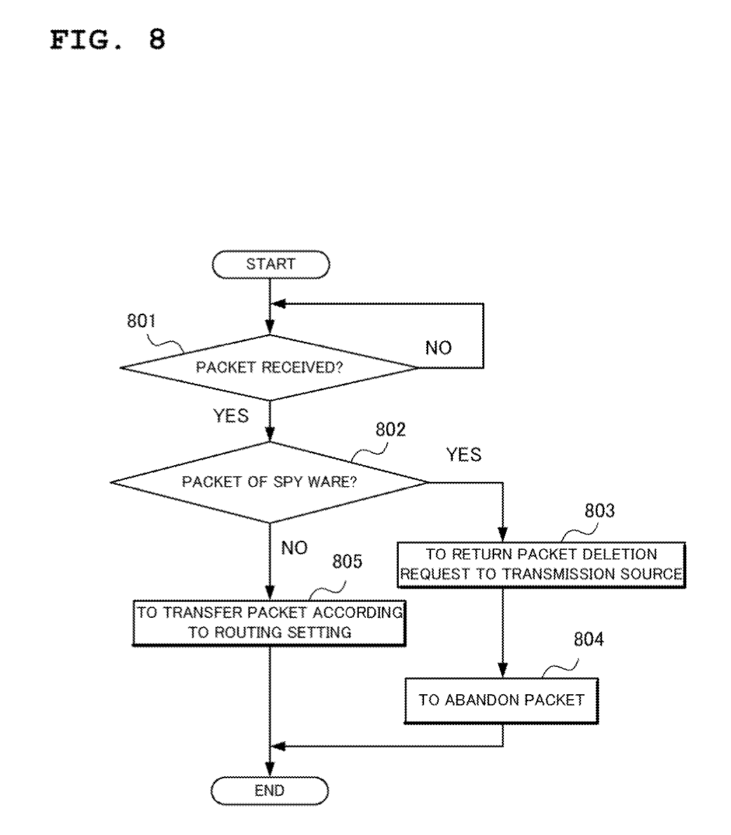

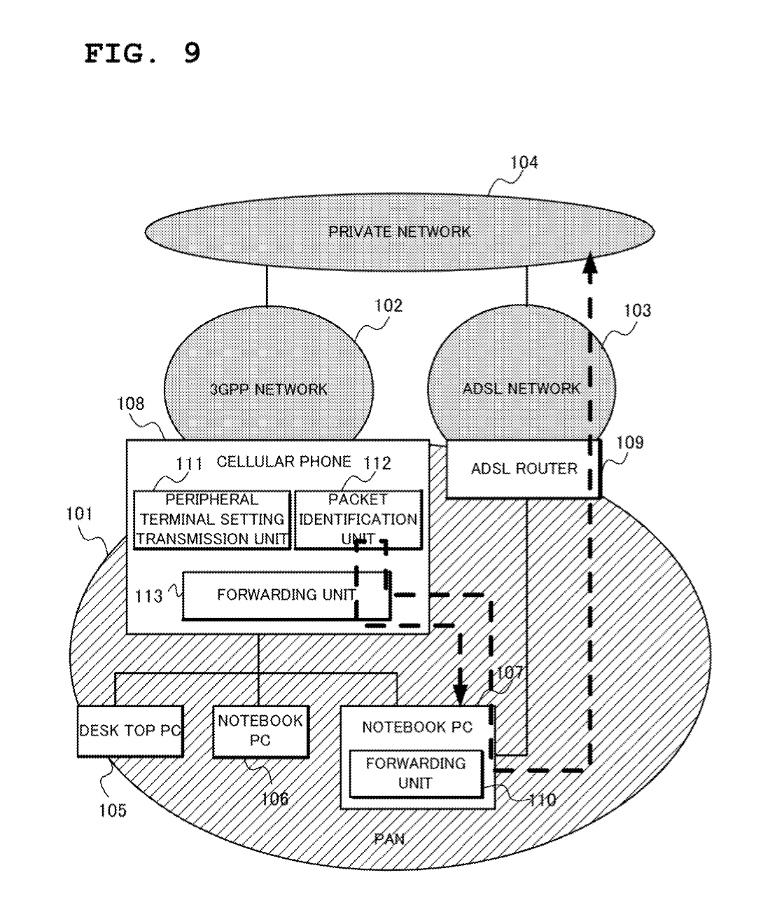

Next, operation of the network system according to the second mode of implementation will be described with reference to FIG. 6, FIG. 7 and FIG. 8. In FIG. 6, an arrow indicates a flow of a packet in an upstream or downstream direction. In addition, FIG. 7 is a flow chart showing operation of the portable terminal 21 and FIG. 8 is a flow chart showing operation of the gateway device 22.

When a user wants to prevent information flow by using the packet identification function at the time of an access from the peripheral terminal 20 to the service network 17, the UI on the portable terminal 21 is given an instruction to that effect.

Upon receiving the instruction from the peripheral terminal 20 (Step 701), the peripheral terminal setting transmission unit 25 of the portable terminal 21 transmits, to the peripheral terminal 20, forwarding setting information formed to use only a direct link between the two terminals but not a link between the peripheral terminal 20 and the broadband router 23 at the time of communication (Step 702).

The forwarding unit 24 of the peripheral terminal 20 will execute all the communication by router connection via the portable terminal 21 or connection such as PPP terminated at the gateway 22 of the cellular network 15 according to the forwarding setting information received from the portable terminal 21.

The packet identification unit 26 of the gateway device 22 of the cellular network 15 once intercepts a packet passing upstream or downstream and receives the same (Step 801), and refers to header information of the packet to determine whether the packet includes data of spy ware or the like (Step 802).

Upon detecting a packet including malware such as spy ware, the packet identification unit 26 of the gateway device 22 returns a deletion request with a copy of the packet attached (together with alarming information that the packet includes malware such as spy ware) to a transmission source such as the peripheral terminal 20 (Step 803) and abandons the packet without transferring the same (Step 804).

Thus, by returning a packet deletion request to a transmission source, further transmission of a packet of the same kind from the same transmission source can be suppressed.

When the determination is made at Step 304 that it is not a packet including malware such as spy ware, the gateway device 22 transfers the received packet according to the routing setting (Step 805).

As to an upstream packet not abandoned by the packet identification unit 26 of the gateway device 22, it will be transferred by a path formed of the peripheral terminal 20, the portable terminal 21 and the gateway 22.

### (Other Modes of Implementation)

While in the first and second modes of implementation, the packet identification unit 12 of the portable terminal 8 or the packet identification unit 26 of the gateway device 22 makes determination whether both upstream and downstream packets are packets including data of malware such as spy ware, it is possible to make determination only of an upstream packet, limiting an object to prevention of information flow from a peripheral terminal.

In a case where the portable terminal 8 according to the first mode of implementation is a multi-access terminal, when a user has authorization to change setting of the broadband router 9, it is possible to receive a downstream packet via the broadband link not by sending out a packet directed to an IP address of the portable terminal 8 side I/F of the peripheral terminal to a port directed to the portable terminal but by correlating the packet to be sent to the port directed to the peripheral terminal in forwarding setting of the broadband router 9.

While the description has been made assuming that the first mode of implementation and the second mode of implementation have different structures, it is possible to assume a structure including both the structures. More specifically, when the packet identification units are disposed in the portable terminal and the gateway device and the portable terminal fails to have a sufficient processing capacity to determine packet identification, among possible structures is a structure in which the packet identification unit of the gateway device is used without using the packet identification unit of the portable terminal.

### First Exemplary Embodiment

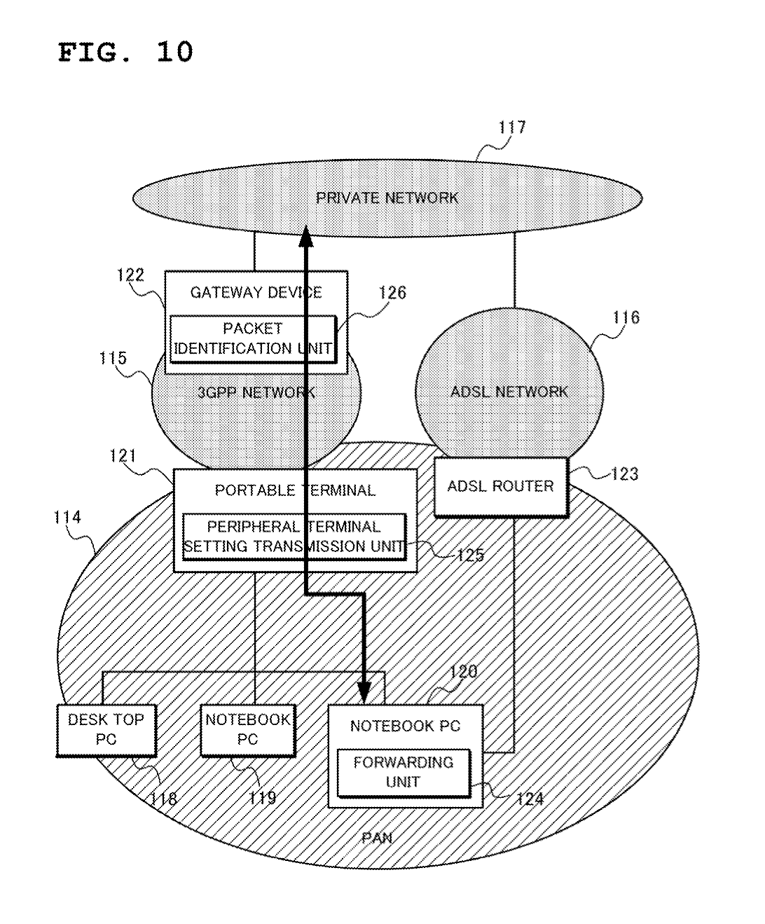

Next, description will be made with reference to FIG. 9 and FIG. 10 with respect to an exemplary embodiment in which a user owing a cellular phone which subscribes to 3GPP service accesses a private network by using a notebook PC which subscribes to ADSL service.

Structure of the first exemplary embodiment is shown in FIG. 9. The first exemplary embodiment corresponds to the above-described first mode of implementation.

A cellular phone 108 is a terminal which subscribes to service of a 3GPP network 102 and uses the service, and comprises a peripheral terminal setting transmission unit 111, a packet identification unit 112 and a forwarding unit 113.

The cellular phone 108, a desk top PC 105, notebook PCs 106 and 107 and an ADSL router 109 are connected by the PAN 101.

The notebook PC 107 is a terminal which subscribes to service of an ADSL network 103 and comprises a forwarding unit 110.

The cellular phone 108 and the desk-top PC 105 or the notebook PC 106 or 107 as a peripheral terminal are connected with each other by radio LAN, Bluetooth, or the like.

The cellular phone 108 owned by a user is a multi-access terminal having a wide band direct link such as radio LAN with the ADSL router 109 other than a connection link with the 3GPP network 102 in one case and is a single-access terminal having only the connection link with the 3GPP network 102 in another case.

(1) In Case where the Cellular Phone 108 is Multi-Access Terminal

When a user wants to prevent information flow by using a function of the packet identification unit 112 at the time of an access from the notebook PC 107 to a private network (the private network 104), the UI of the cellular phone 108 is given an instruction to that effect.

The peripheral terminal setting transmission unit 111 of the cellular phone 108 transmits, to the notebook PC 107, forwarding setting information formed to use only a direct link between the two terminals but not a link between the notebook PC 107 and the ADSL router 109 at the time of communication.

The forwarding unit 110 of the notebook PC 107 will execute all the communication by router connection via the cellular phone 108 according to the forwarding setting information received from the cellular phone 108.

The packet identification unit 112 of the cellular phone 108 once intercepts a packet passing upstream or downstream and receives the same to refer to header information including a protocol type, a transmission source/transmission destination transport layer port number, a transmission source/transmission destination IP address and the like, thereby determining whether the received packet is a packet including spy ware or the like.

Upon detecting a packet including malware such as spy ware, return a deletion request with a copy of the packet attached (together with alarming information that the packet includes malware such as spy ware) to a transmission source such as the notebook PC 107 and abandon the packet without transferring the same.

At that time, it is also possible to manually drop a process related to transmission of the packet by analyzing the deletion request (warning information) received by the user using the notebook PC 107. In such a case, even if the user refrains from dropping a process, a packet including malware such as spy ware which is received thereafter will be abandoned by the packet identification unit 112 of the cellular phone 108.

As to an upstream packet not abandoned by the packet identification unit 112, the forwarding unit 113 of the cellular phone 108 transfers the packet not to the 3GPP network 102 side but to the direct link with the ADSL router 109 to transmit the same by using the ADSL network 103.

Similarly, a downstream packet will be also directly received by the cellular phone 108 from the ADSL router 109 and forwarded to the notebook PC 107.

(2) In Case where the Cellular Phone 108 is Single-Access Terminal

When a user wants to prevent information flow by using the packet identification function at the time of an access from the notebook PC 107 to the private network 104, the UI of the cellular phone 108 is given an instruction to that effect.

The peripheral terminal setting transmission unit 111 of the cellular phone 108 transmits, to the notebook PC 107, forwarding setting information formed to operate as a bridge for a packet again received from the cellular phone 108 to connect to the ADSL router 109, with the cellular phone 108 as a Default Gateway at the time of communication.

The forwarding unit 110 of the notebook PC 107 will operate as a bridge in communication between the cellular phone 108 and the ADSL router 109, with the cellular phone 108 as the Default Gateway according to the forwarding setting information received from the cellular phone 108.

The packet identification unit 112 of the cellular phone 108 once intercepts a packet passing upstream or downstream and receives the same to refer to header information including a protocol type, a transmission source/transmission destination transport layer port number, a transmission source/transmission destination IP address and the like, thereby determining whether the received packet is a packet including spy ware or the like.

Upon detecting a packet including malware such as spy ware, return a deletion request with a copy of the packet attached (together with alarming information that the packet includes spy ware or the like) to a transmission source such as the notebook PC 107 and abandon the packet without transferring the same.

At that time, it is also possible to manually analyze the deletion request (warning information) received by the user using the notebook PC 107 to drop a process related to transmission of the packet. In such a case, even if the user refrains from dropping a process, a packet including malware such as spy ware which is received thereafter will be abandoned by the packet identification unit 112 of the cellular phone 108.

As to an upstream packet not abandoned by the packet identification unit 112, the forwarding unit 113 of the cellular phone 108 makes L2 connection with a LAN side MAC address of the ADSL router 109 as a destination to transmit the packet to the ADSL network 103 by using the notebook PC 107 as a bridge.

Similarly, a downstream packet will pass through the cellular phone 108 from the ADSL router 109 with the notebook PC 107 as a bridge and be again forwarded to the notebook PC 107.

### Second Exemplary Embodiment

Structure of a second exemplary embodiment is shown in FIG. 10. The second exemplary embodiment corresponds to the above-described second mode of implementation.

A portable terminal 121 is a terminal which subscribes to service of a 3GPP network 115 and uses the service and comprises a peripheral terminal setting transmission unit 125.

A gateway device 122 is a gateway device under the management of an operator of the 3GPP network 115 and comprises a packet identification unit 126.

The portable terminal 121, a desk top PC 118, notebook PCs 119 and 120 and an ADSL router 123 are connected with each other by a PAN 114.

The notebook PC 120 is a terminal which subscribes to service of an ADSL network 116 and comprises a forwarding unit 124.

The portable terminal 121 and the desk-top PC 118 or the notebook PC 119 or 120 as a peripheral terminal are connected by radio LAN, Bluetooth, or the like.

When a user wants to prevent information flow by using the packet identification function at the time of an access from the notebook PC 120 to a private network 117, the UI of the portable terminal 121 is given an instruction to that effect.

The peripheral terminal setting transmission unit 125 of the portable terminal 121 transmits, to the notebook PC 120, forwarding setting information formed to use only a direct link between the two terminals but not a link between the notebook PC 120 and the ADSL router 123 at the time of communication.

The forwarding unit 124 of the notebook PC 120 will execute all the communication by router connection via the portable terminal 121 or connection such as PPP terminated at the gateway 122 of the 3GPP network 115 according to the forwarding setting information received from the portable terminal 121.

The packet identification unit 126 of the gateway 122 in the 3GPP network 115 once intercepts a packet passing upstream or downstream and receives the same to refer to header information including a protocol type, a transmission source/transmission destination transport layer port number, a transmission source/transmission destination IP address and the like, thereby determining whether the received packet is a packet including spy ware or the like.

Upon detecting a packet including malware such as spy ware, return a deletion request with a copy of the packet attached (together with alarming information that the packet includes spy ware or the like) to a transmission source such as the notebook PC 120 and abandon the packet without transferring the same.

At that time, it is also possible to manually drop a process related to transmission of the packet by analyzing the deletion request (warning information) received by the user using the notebook PC 120. In such a case, even if the user refrains from dropping a process, a packet including spy ware or the like which is received thereafter will be abandoned by the packet identification unit 126 of the gateway 122.

Hereafter, an upstream or downstream packet will be transferred by a path formed of the notebook PC 120, the portable terminal 121 and the gateway 122.

In the present exemplary embodiment of the present invention, as described above, when a user wants to prevent information flow by using the packet identification function at the time of an access from a first user terminal (peripheral terminal) to a specific service network, a second user terminal (portable terminal) is given an instruction to that effect.

Upon receiving the instruction from the first user terminal (peripheral terminal), the second user terminal (portable terminal) transmits, to the first user terminal (peripheral terminal), forwarding setting information formed to make connection via the second user terminal.

The second user terminal (portable terminal) or the packet identification unit of the gateway device once intercepts a packet passing upstream or downstream and refers to header information of the packet to detect data of spy ware or the like. Upon detecting a packet of spy ware or the like, abandon the packet and when the packet is not that of spy ware or the like, transfer the packet according to the forwarding setting information.

A forwarding unit of the second user terminal (portable terminal) transmits an upstream packet not abandoned by the packet identification unit by a direct link with a first service network (broadband network) or by using the first service network (broadband network) with the first user terminal (peripheral terminal) as a bridge. Similarly, a downstream packet will be forwarded to the first user terminal (peripheral terminal) by a return path of these paths.

According to the forwarding setting information received from the second user terminal (portable terminal), a forwarding unit of the first user terminal (peripheral terminal) executes communication by connection via the second user terminal (portable terminal), bridge connection which returns at the second user terminal (portable terminal), or the like.

Although the present invention has been described with respect to the preferred modes of implementation and exemplary embodiments in the foregoing, the present invention is not necessarily limited to the above-described modes of implementation and exemplary embodiments and can be implemented in various forms without departing from the technical spirit and scope of the present invention.

### INCORPORATION BY REFERENCE

The present application claims priority based on Japanese Patent Application No. 2007-061104, filed on Mar. 9, 2007 and incorporates all the disclosure of the same.

1. A network system with a first user terminal which uses a first service network and a second user terminal which uses a second service network connected by a first network, wherein when said first user terminal accesses other service network through said first service network,
said second user terminal transmits, to said first user terminal, forwarding setting information formed to connect to said first service network via the second user terminal, and
when a packet communicated between said first user terminal and said other service network is malware, said second user terminal abandons the packet and when not malware, transfers the packet according to said forwarding setting information.

2. The network system according to claim 1, wherein
said second user terminal comprises a unit which transmits said forwarding setting information to said first user terminal, a packet identification unit which identifies a packet including said malware, and a forwarding unit which transfers a packet from said first user terminal to said first service network or to said first user terminal, and
said first user terminal comprises a forwarding unit which forwards communication with said other service network via said second user terminal according to said forwarding setting information received from said second user terminal.

3. The network system according to claim 2, wherein
said second user terminal has a direct link with said first service network, and
the forwarding unit of said first user terminal forwards communication through the direct link via said second user terminal.

4. The network system according to claim 2, wherein the forwarding unit of said first user terminal forwards communication, with said second user terminal as a gateway and with said first user terminal as a bridge in communication between said second user terminal and said first service network.

5. The network system according to claim 2, wherein by referring to header information of an intercepted packet, said packet identification unit of said second user terminal detects a packet including said malware.

6. The network system according to claim 2, wherein when detecting a packet including said malware, said packet identification unit of said second user terminal transmits a request for deleting the packet to a transmission source of the packet.

7. A network system with a first user terminal which uses a first service network and a second user terminal which uses a second service network connected by a first network, wherein when said first user terminal accesses other service network through said second service network,
said second user terminal transmits, to said first user terminal, forwarding setting information formed to connect to said second service network via the second user terminal, and
when a packet communicated between said first user terminal and said other service network is malware, a gateway device of said second service network abandons the packet and when not malware, transfers the packet.

8. The network system according to claim 7, wherein
said gateway device of said second service network comprises a packet identification unit which identifies a packet including said malware,
said second user terminal comprises a unit which transmits said forwarding setting information to said first user terminal, and
said first user terminal comprises a forwarding unit which forwards communication with said other service network via said second user terminal according to said forwarding setting information received from said second user terminal.

9. The network system according to claim 8, wherein the forwarding unit of said first user terminal forwards communication with said other service network through connection terminated at said gateway device.

10. The network system according to claim 8, wherein by referring to header information of an intercepted packet, said packet identification unit of said gateway device detects a packet including said malware.

11. The network system according to claim 8, wherein when detecting a packet including said malware, said packet identification unit of said gateway device transmits a request for deleting the packet to a transmission source of the packet.

12. A network system with a first user terminal which uses a first service network and a second user terminal which uses a second service network connected by a first network, wherein when said first user terminal accesses other service network,
said second user terminal transmits, to said first user terminal, forwarding setting information formed to connect to said other service network from said first service network via the second user terminal or formed to connect to said other service network via said second user terminal and a gateway device of said second service network, and
when a packet communicated between said first user terminal and said other service network is malware, said second user terminal or said gateway device abandons the packet and when not malware, transfers the packet according to said forwarding setting information.

13. A communication method in a network system with a first user terminal which uses a first service network and a second user terminal which uses a second service network connected by a first network, wherein when said first user terminal accesses other service network through said first service network,
said second user terminal transmits, to said first user terminal, forwarding setting information formed to connect to said first service network via the second user terminal, and
when a packet communicated between said first user terminal and said other service network is malware, said second user terminal abandons the packet and when not malware, transfers the packet according to said forwarding setting information.

14. The communication method according to claim 13, wherein
said second user terminal transmits said forwarding setting information to said first user terminal, identifies a packet including said malware, and transfers a packet from said first user terminal to said first service network or to said first user terminal, and
said first user terminal forwards communication with said other service network via said second user terminal according to said forwarding setting information received from said second user terminal.

15. The communication method according to claim 14, wherein
said second user terminal has a direct link with said first service network, and
said first user terminal forwards communication through the direct link via said second user terminal.

16. The communication method according to claim 14, wherein said first user terminal forwards communication, with said second user terminal as a gateway and with said first user terminal as a bridge in communication between said second user terminal and said first service network.

17. The communication method according to claim 14, wherein by referring to header information of an intercepted packet, said second user terminal detects a packet including said malware.

18. The communication method according to claim 13, wherein when detecting a packet including said malware, said second user terminal transmits a request for deleting the packet to a transmission source of the packet.

19. A communication method in a network system with a first user terminal which uses a first service network and a second user terminal which uses a second service network connected by a first network, wherein when said first user terminal accesses other service network through said second service network,
said second user terminal transmits, to said first user terminal, forwarding setting information formed to connect to said second service network via the second user terminal, and
when a packet communicated between said first user terminal and said other service network is malware, a gateway device of said second service network abandons the packet and when not malware, transfers the packet.

20. The communication method according to claim 19, wherein
said gateway device of said second service network identifies a packet including said malware,
said second user terminal transmits said forwarding setting information to said first user terminal, and
said first user terminal forwards communication with said other service network via said second user terminal according to said forwarding setting information received from said second user terminal.

21. The communication method according to claim 20, wherein said first user terminal forwards communication with said other service network through connection terminated at said gateway device.

22. The communication method according to claim 19, wherein by referring to header information of an intercepted packet, said gateway device detects a packet including said malware.

23. The communication method according to claim 19, wherein when detecting a packet including said malware, said gateway device transmits a request for deleting the packet to a transmission source of the packet.

24. A communication method in a network system with a first user terminal which uses a first service network and a second user terminal which uses a second service network connected by a first network, wherein when said first user terminal accesses other service network,
said second user terminal transmits, to said first user terminal, forwarding setting information formed to connect to said other service network from said first service network via the second user terminal or formed to connect to said other service network via said second user terminal and a gateway device of said second service network, and
when a packet communicated between said first user terminal and said other service network is malware, said second user terminal or said gateway device abandons the packet and when not malware, transfers the packet according to said forwarding setting information.

25. A communication terminal connected by a network to a user terminal which uses a first service network to use second service network, comprising:
when said user terminal accesses other service network through said first service network, a unit which transmits, to said user terminal, forwarding setting information formed to connect to said first service network via the communication terminal;
a unit which abandons, when a packet communicated between said user terminal and said other service network is malware, the packet; and
a unit which transfers, when a packet is not malware, the packet according to said forwarding setting information.

26. A computer readable medium storing a communication program for controlling communication in a network system with a first user terminal which uses a first service network and a second user terminal which uses a second service network connected by a first network, said communication program, when said first user terminal accesses other service network via said first service network, causes said second user terminal to execute:
a function of transmitting, to said first user terminal, forwarding setting information formed to connect to said first service network via the second user terminal; and
a function of abandoning, when a packet communicated between said first user terminal and said other service network is malware, the packet, and transferring, when a packet is not malware, the packet according to said forwarding setting information.

27. A computer readable medium storing a communication program for controlling communication in a network system with a first user terminal which uses a first service network and a second user terminal which uses a second service network connected by a first network, said communication program, when said first user terminal accesses other service network through said second service network, causes,
said second user terminal to execute the function of transmitting, to said first user terminal, forwarding setting information formed to connect to said second service network via the second user terminal, and
a gateway device of said second service network to execute the function of abandoning, when a packet communicated between said first user terminal and said other service network is malware, the packet, and when a packet is not malware, transferring the packet.

28. A network system with a first user terminal which uses a first service network and a second user terminal which uses a second service network connected by a first network, wherein when said first user terminal accesses other service network through said first service network,
said second user terminal transmits, to said first user terminal, forwarding setting information formed to connect to said first service network via the second user terminal.

29. A network system with a first user terminal which uses a first service network and a second user terminal which uses a second service network connected by a first network, wherein when said first user terminal accesses other service network through said second service network,
said second user terminal transmits, to said first user terminal, forwarding setting information formed to connect to said second service network via the second user terminal.

30. A network system with a first user terminal which uses a first service network and a second user terminal which uses a second service network connected by a first network, wherein when said first user terminal accesses other service network,
said second user terminal transmits, to said first user terminal, forwarding setting information formed to connect to said other service network from said first service network via the second user terminal or formed to connect to said other service network via said second user terminal and a gateway device of said second service network.
